(19) United States
(12) Patent Application Publication
(10) Pub. No.: US 2006/0282471 A1
(43) Pub. Date: Dec. 14, 2006

(54) Error checking file system metadata while the file system remains available

(76) Inventors: Timothy W. Mark, Goffstown, NH (US); David G. Akers, Merrimack, NH (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/151,011

(22) Filed: Jun. 13, 2005

(51) Int. Cl. G06F 17/30

(52) U.S. Cl. 707/200

(57) ABSTRACT

File system metadata associated with a file system is stored. A snapshot of the file system metadata is created, and a change of the file system is allowed while the snapshot is being created. An error check is run with respect to the snapshot of the file system metadata to check for an error in the snapshot of the file system metadata while the file system remains available. Access of one or more files associated with the file system is enabled while the error check is being run with respect to the snapshot of the file system metadata.

### BACKGROUND

Data can be stored in various types of storage devices, including magnetic storage devices (such as magnetic disk drives), optical storage devices, integrated circuit storage devices, and so forth. Data stored in storage devices includes user data and metadata. The term “user data” refers to user-created data, program instructions, data associated with applications or other software, and the like. “Metadata” is information that describes the stored user data. Examples of metadata include file names, ownership and access rights, last modified date, file size, and other information relating to the structure, content, and attributes of files containing user data. Metadata stored by a file system is referred to as file system metadata. A file system is a mechanism for storing and organizing user data to allow software in a computer to easily find and access the user data.

In response to detecting a problem occurring in a system, or as part of preventative maintenance, file system metadata can be checked for errors, such as metadata inconsistencies. Usually, a system administrator runs a file system metadata checking tool to perform metadata consistency checking. Performing consistency checking of file system metadata associated with a large number of files can be time-consuming. The amount of time for performing consistency checking of file system metadata grows linearly with the number of files in the file system.

Usually, a file system has to be first unmounted (or otherwise taken offline) before a file system metadata checking tool can be run against the file system metadata. During the period of time that the file system is offline for the purpose of performing consistency checking, the file system and consequently user data managed by the file system is unavailable for access by system software.

Other types of file system metadata checking tools are able to perform metadata checking while a file system remains online (available for access by software). However, since the metadata can be changing while the file system is online, the results can often be unreliable. Also, other conventional file system metadata checking tools that perform metadata checking while a file system remains online typically implement certain restrictions, such as preventing all writes at some point during the metadata checking process. Such restrictions may slow down the file system metadata checking process.

### BRIEF DESCRIPTION OF THE DRAWINGS

FIG. 1 is a block diagram of an example system that includes a file system metadata checking utility, according to an embodiment.

FIG. 2 is a flow diagram of a process of error checking metadata using the file system metadata checking utility, according to an embodiment.

### DETAILED DESCRIPTION

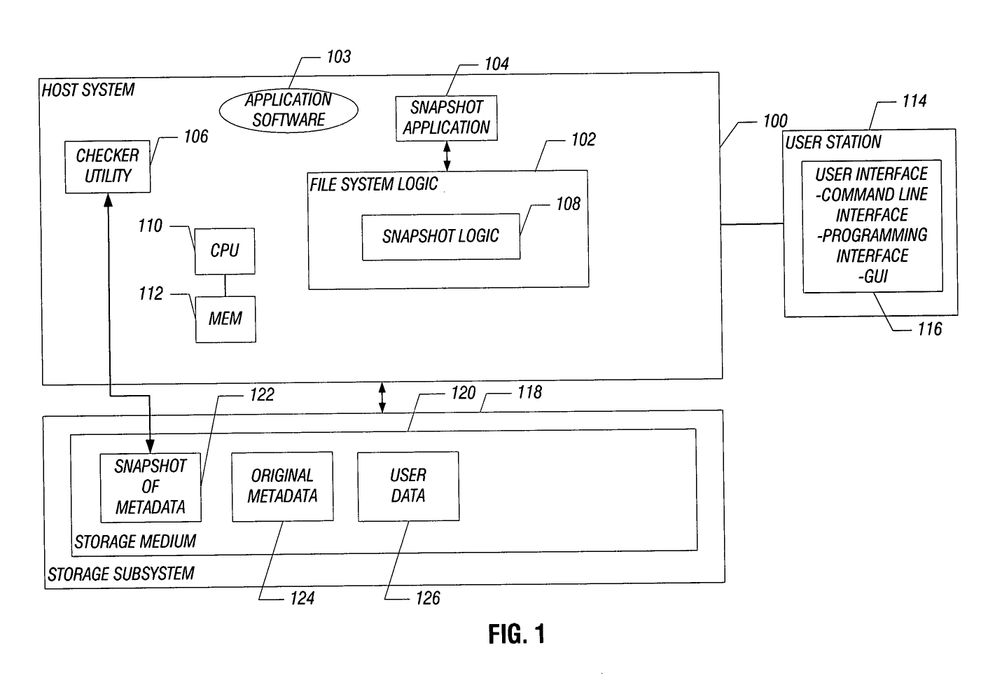

As depicted in FIG. 1, a host system 100 is coupled to a storage subsystem 118, where the storage subsystem 118 includes a storage medium 120 for storing user data 126. Note that although the storage subsystem 118 is shown as separate from the host system 100, the storage subsystem 118 can be part of the host system 100. Also, the label “host” is used for purposes of example, as mechanisms according to some embodiments can be used in other types of computer systems in other implementations. The storage subsystem 118 can be implemented with various types of storage devices, including disk-based storage devices, integrated circuit storage devices, and other types of storage devices. Examples of the storage medium 120 include disk-based storage medium (e.g., magnetic or optical disk or disks), integrated circuit-based storage medium, nanotechnology or microscopy-based storage medium, or other types of storage media. The term “storage medium” refers to either a single storage medium or multiple storage media (e.g., multiple disks, multiple chips, etc.).

In FIG. 1, the user data 126 stored on the storage medium 120 includes data that is associated with either a user, application, or other software in a computer system. Examples of user data include user files, software code, and data maintained by applications or other software.

To manage access of and to organize the user data 126, the system including the host system 100 and storage subsystem 118 has a file system. A file system is usually part of an operating system. The file system includes file system logic 102 that is executable in the host system 100 and file system metadata 124 that describes the user data 126. The file system allows software (e.g., application software 103) in the host system 100 to easily find and access user data 126. Examples of file system metadata include file names, ownership and access rights, last modified date, file size, and other information relating to the structure, content, and attributes of files containing the user data 126. A file system thus includes the file system logic 102, file system metadata, and user data. A change to either the user data or the file system metadata is considered a change to the file system.

In FIG. 1, file system metadata 124 is referred to as “original” file system metadata to indicate file system metadata that is actually used by the file system logic 102 when accessing the user data 126. The original file system metadata 124 is contrasted with a snapshot 122 of the file system metadata, which is a copy of the original file system metadata. A “snapshot” is a copy of data, in this case the original file system metadata 124, created at a given point in time.

The original file system metadata 124 is subject to corruption or inconsistency as a result of various causes, including malfunction of the storage subsystem 118 (e.g., the storage subsystem writing to a particular block on the storage medium 120 when the storage subsystem 118 should have written to another block on the storage medium); mistakes made by a system administrator (e.g., the system administrator powering off a storage subsystem cache or other component by mistake); and file system programming errors (e.g., bugs in the file system). Other causes of file system metadata corruption or inconsistency also exist. Metadata corruption or inconsistency may cause errors during access of user data by the file system. Corruption of file system metadata refers to any damage to the metadata caused by errors or failures in software, hardware, or both. Inconsistency of file system metadata refers to different parts or pieces of the metadata that are inconsistent with one another.

The host system 100 includes a metadata checker utility 106 that performs a check for errors in file system metadata. Checking for errors in file system metadata includes checking for metadata inconsistency or corruption, or for any other problem of the metadata that would prevent proper access of the user data 126 by the file system logic 102.

Examples of metadata consistency checking include performing cross-checks between different pieces of the metadata to ensure that the different pieces are synchronized (consistent with each other). In one exemplary embodiment, the file system includes a metadata file that maps segments of the physical storage medium 120 to files containing user data. This metadata file is usually referred to as a storage map or the like. With respect to the storage map, a consistency check involves examining all the files in the file system and building a copy of what the storage map should look like. The copy of the storage map is then compared with the actual storage map to determine if the actual storage map accurately maps segments of the storage medium 120 to files containing the user data 126.

Another type of consistency checking involves performing sanity checking with respect to individual information fields of file system metadata, where the individual information fields of the file system metadata are examined to ensure that the values contained in the information fields are “sane” values (in other words, the values of the information fields are within ranges of expected values). For example, if a file system is not supposed to span more than 128 disks making up the storage medium 120, and a “number of disks” information field in the file system metadata is 532, then the metadata checker utility 106 will report this “number of disks” information field as being inconsistent.

Another consistency check that can be performed involves checking the relationships between directories and files. If a file “X” has file system metadata that indicates that the file “X” is in a directory “Y,” but the directory “Y” does not actually have an entry for file “X,” then the metadata checker utility 106 will report this as an inconsistency.

There are numerous other types of consistency checks that can be performed by the metadata checker utility 106. Also, in addition to consistency checks, other types of errors are detectable by the metadata checker utility 106, including corruption of the file system metadata or other problems associated with the metadata.

If a file system is large, then the error checking performed by the metadata checker utility 106 of the file system metadata can take a relatively long time. Thus, if the file system has to be unmounted (or otherwise taken offline) to perform the error checking, then the file system becomes unavailable for access by software in the host system 100 or by external devices (external to the host system 100) during this offline period.

To avoid having to take the file system offline to perform error checking by the metadata checker utility 106, the snapshot 122 of the file system metadata is first created. The metadata checker utility 106 then performs error checking on the snapshot 122 of file system metadata, rather than on the original file system metadata 124. In one embodiment, the snapshot 122 is taken based on cooperation between a snapshot application 104 in the host system 100 and snapshot logic 108 in the file system logic 102. Note that although two separate snapshot blocks are depicted (the snapshot application 104 and snapshot logic 108), it is contemplated that the tasks performed by the snapshot application 104 and snapshot logic 108 can be combined into a single module. Alternatively, the snapshot application 104 can be omitted. The snapshot application 104 is created by a user, such as a user at a user station 114 that is coupled to the host system 100 (over a network). The user station 114 has a user interface 116 that can contain various elements, such as a command line interface, a programming interface, or a graphical user interface (GUI). The programming interface can be used to create the snapshot application 104, which issues commands to the snapshot logic 108 in the file system logic 102 to create the snapshot 122 of file system metadata. Alternatively, instead of creating a snapshot application 104 to issue commands to the snapshot logic 108, a user can issue commands to the snapshot logic 102 through the command line interface of the user interface 116. Commands can also be issued through the GUI of the user interface 116 in alternative implementations.

In response to commands (from the snapshot application 104, from the command line interface or GUI on the user station 114, or from some other source), the snapshot logic 108 creates the snapshot 122 of the original file system metadata 124. Note that the created snapshot 122 contains a copy of the file system metadata, but not a copy of the user data. Copying just the file system metadata in the snapshot 122 utilizes much less storage space than copying the entire file system into the snapshot 122. The commands can be issued by a user action; or alternatively, the commands to take the snapshot can be based on a set time or other event in the host system 100 (as detected by the snapshot application 104). As an example, the snapshot 122 of file system metadata can be taken periodically, such as every hour, every day, every week, every month, and so forth. Other events that can cause the snapshot 122 of file system metadata to be taken include detection of certain types of errors in the host system 100 that may be indications of corruption, inconsistency, or some other problem in the original file system metadata 124. By running the metadata checker utility 106 against the snapshot 122 of file system metadata, rather than against the original file system metadata 124, the file system does not have to be unmounted (or otherwise taken offline) so that software in the host system 100, such as application software 103 or an external device, can continue to access the user data 126 through the file system based on the original file system metadata 124. Thus, a file system is said to be online or available if software is able to access the file system for the purpose of accessing user data. Concurrently with normal file system operations, the metadata checker utility 106 is able to run error checking against the snapshot 122 of file system metadata.

The various software modules in the host system, including the metadata checker utility 106, the snapshot application 104, application software 103, and file system logic 102 are executable on a central processing unit (CPU) 110, or plural CPUs. The CPU 110 is coupled to memory 112 in the host system 100.

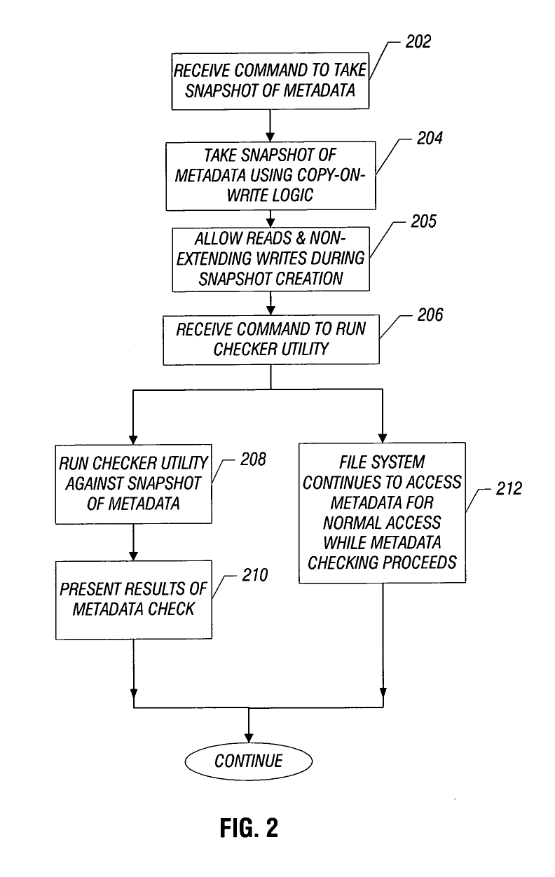

FIG. 2 shows a flow diagram of a process of performing error checking of file system metadata. The snapshot logic 108 in the file system logic 102 receives (at 202) a command to take a snapshot of the original file system metadata 124. As noted above, the command can be issued by a user, at a set time, or in response to another event. In response to the command, the snapshot logic 108 creates (at 204) the snapshot 122 of file system metadata by copying the content of the original file system metadata 124 to another section of the storage medium 120 to store the metadata copy (snapshot 122). The snapshot 122 is effectively a copy or frozen image of the original file system metadata 124 at the time the snapshot was created. Creation of the snapshot 122 is relatively quick (e.g., involving a few seconds or less) in some implementations. During the time period that the snapshot 122 is being created, changes to the original file system metadata 124 are suspended. However, even during the snapshot creation period, file system operations that do not involve certain metadata changes can still occur, such as reads or non-extending writes (a non-extending write is a write to a file that does not involve the file system allocating additional storage for the file).

A non-extending write changes user data, but does not change file system metadata that are required by a file system standard (e.g., POSIX file system standard) to occur synchronously with update of the user data. A non-extending write changes a file system (which includes the user data). Also, a non-extending write changes a “last update time” field of the corresponding file system metadata. However, the change to the “last update time” field can be updated at a later time, rather than synchronously with the update of the user data. A file system metadata change occurs “synchronously” with a user data change if the file system metadata change occurs at substantially the same time as the user data change. By allowing reads and non-extending writes (at 205) during creation of the snapshot, system throughput is enhanced since such operations are allowed to proceed even during snapshot creation. Techniques according to some embodiments that allow non-extending writes to occur during snapshot creation are more efficient than techniques that would block or prohibit any operations that would change the file system.

Also, according to some embodiments, creation of the snapshot of the file system metadata can proceed even if dirty data (dirty metadata or dirty user data) resides in a cache, such as in a cache in the memory 112 or elsewhere. In other words, according to these embodiments, creation of the snapshot does not have to wait for flushing or synchronization of dirty data from a cache to persistent storage such as the storage medium 118.

Once the snapshot 122 has been created, then any file system operation can proceed, even file system operations that involve metadata changes.

In one implementation, the snapshot 122 is created using copy-on-write logic. Copy-on-write refers to taking a snapshot before a write is executed. In the metadata context, copy-on-write refers to taking the snapshot of the original file system metadata 124 before a write is performed on the original file system metadata 124.

In some embodiments, the snapshot 122 contains the entirety of the original file system metadata 124 (at a particular point in time). In other embodiments, the snapshot 122 can contain a subset (less than all) of the original file system metadata 124.

After the snapshot 122 is created, a command is received (at 206) to run the metadata checker utility 106. In response to this command, the metadata checker utility is run (at 208) against the snapshot 122 of file system metadata. Results of the metadata check are then presented (at 210). For example, the results can be presented through the user interface 116 of the user station 114, in the form of a report, graphical output, text output, and so forth. The results can also be stored in the host system 100, or in the user station 114, for later access by a user. Any errors detected as a result of this metadata check is addressed by a user by modifying the original file system metadata 124 to fix any inconsistencies or other errors.

While the metadata checker utility runs (at 208) the metadata error checking against the snapshot 122 of file system metadata, the file system remains online (available) so that the file system logic 102 continues to be able to access the original file system metadata 124 for normal access of the user data while the metadata checking proceeds.

In this manner, metadata checking and normal file system service can both occur in parallel, which eliminates the often lengthy downtime associated with metadata checking in conventional systems.

The flow diagram of FIG. 2 is exemplary, where the acts/blocks of the figure can be added, removed, altered, and so forth, and still be covered by embodiments of the invention.

Instructions of software routines described herein (including the metadata checker utility 106, the snapshot application 104, application software 103, and file system logic 102 in FIG. 1) are loaded for execution on a processor (e.g., CPU 110). The processor includes microprocessors, microcontrollers, processor modules or subsystems (including one or more microprocessors or microcontrollers), or other control or computing devices.

Data and instructions (of the software) are stored in respective storage devices, which are implemented as one or more machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video disks (DVDs).

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method of software execution comprising:
storing file system metadata associated with a file system;
creating a snapshot of the file system metadata;
performing at least a first type of write to change user data while the snapshot is being created;
running an error check with respect to the snapshot of the file system metadata to check for an error in the snapshot of the file system metadata while the file system remains available; and
allowing access of user data associated with the file system while the error check is being run with respect to the snapshot of the file system metadata.

2. The method of claim 1, wherein performing the first type of write comprises performing a non-extending write.

3. The method of claim 1, wherein performing the first type of write comprises performing a write that changes the user data without changing file system metadata synchronously with the change of the user data.

4. The method of claim 1, wherein creating the snapshot occurs even though dirty data resides in a cache that has not been flushed to persistent storage.

5. The method of claim 1, wherein running the error check comprises performing a consistency check of the snapshot of file system metadata.

6. The method of claim 5, wherein performing the consistency check comprises cross-checking different pieces of the snapshot of the file system metadata to determine consistency between the different pieces.

7. The method of claim 5, wherein performing the consistency check comprises at least one of (1) checking a storage map of files to determine that the storage map accurately reflects actual files stored on a storage medium, (2) checking a value of at least one information field in the snapshot of the metadata to determine whether the value is within an expected range, and (3) verifying that the file system metadata accurately indicates a file is located in a particular directory.

8. The method of claim 1, wherein creating the snapshot comprises copying the file system metadata into the snapshot without copying the user data into the snapshot.

9. The method of claim 1, further comprising the file system continuing access of the stored file system metadata while the error checking is being run with respect to the snapshot of the file system metadata.

10. The method of claim 9, further comprising:
storing user data associated with the file system metadata in the one or more files; and
enabling access of the user data based on file system access of the stored file system metadata while the error check is being performed with respect to the snapshot of the file system metadata.

11. The method of claim 1, wherein creating the snapshot comprises creating the snapshot of an entirety of the stored file system metadata.

12. A system comprising:
software;
a storage subsystem to store user data and file system metadata associated with the user data;
file system logic to access the user data based on the file system metadata;
snapshot logic to create a snapshot of the file system metadata stored in the storage subsystem, the snapshot containing a copy of the file system metadata but not a copy of the user data; and
a checker utility to perform error checking of the snapshot of the file system metadata while the file system logic remains available to the software for accessing user data.

13. The system of claim 12, wherein the software comprises application software,
wherein the application software is able to access the user data through the file system logic while the checker utility performs the error checking with respect to the snapshot of the file system metadata.

14. The system of claim 13, wherein the file system logic is adapted to access the stored file system metadata to enable access by the application software of the user data while the checker utility performs error checking with respect to the snapshot of the file system metadata.

15. The system of claim 12, wherein the checker utility is adapted to perform the error checking by performing consistency checking of the snapshot of the file system metadata.

16. The system of claim 15, wherein the consistency checking comprises cross-checking different pieces of the snapshot of the file system metadata to determine consistency between the different pieces.

17. The system of claim 15, wherein the consistency checking comprises at least one of (1) checking a storage map of files to determine that the storage map accurately reflects actual files stored on a storage medium, (2) checking a value of at least one information field in the snapshot of the file system metadata to determine whether the value is within an expected range, and (3) verifying that the file system metadata accurately indicates a file is located in a particular directory.

18. The system of claim 12, further comprising a snapshot application created through a programming interface by a user, the snapshot application to send a command to the snapshot logic to create the snapshot of the file system metadata.

19. The system of claim 18, the snapshot application to detect an event to send the command to the snapshot logic.

20. The system of claim 19, wherein the event comprises a time event.

21. The system of claim 12, wherein a change of a file system is allowed while the snapshot is being created, the file system including the file system logic, the file system metadata, and the user data.

22. The system of claim 21, wherein the change of the file system is caused by a non-extending write.

23. The system of claim 21, wherein the change of the file system is caused by a write that changes user data without changing file system metadata synchronously with the change of the user data.

24. An article comprising at least one storage medium containing instructions that when executed cause a system to:
store file system metadata associated with user data;
create a snapshot of the file system metadata;
perform a change of a file system during creation of the snapshot; and
run an error check with respect to the snapshot of the file system metadata to check for an error in the snapshot of the file system metadata while the stored file system metadata is accessible by software to access user data associated with the stored file system metadata.

25. The article of claim 24, wherein performing the change of the file system comprises performing a non-extending write.

26. The article of claim 24, wherein the instructions when executed cause the system to enable the file system to access the user data based on the stored file system metadata while the error check is being run with respect to the snapshot of the file system metadata.

27. The article of claim 24, wherein the snapshot of the file system metadata represents a copy of the stored file system metadata at a given point in time.

28. The article of claim 24, wherein running the error check with respect to the snapshot of the file system metadata comprises running a consistency check with respect to the snapshot of the file system metadata.

29. The article of claim 28, wherein running the consistency check comprises cross-checking different pieces of the file system metadata to determine consistency between the different pieces.

30. The article of claim 29, wherein running the consistency check comprises at least one of (1) checking a storage map of files to determine that the storage map accurately reflects actual files stored on a storage medium, (2) checking a value of at least one information field in the snapshot of the file system metadata to determine whether the value is within an expected range, and (3) verifying that the file system metadata accurately indicates a file is located in a particular directory.

31. The article of claim 24, wherein creating the snapshot comprises copying the file system metadata into the snapshot without copying the user data into the snapshot.

32. A computer comprising:
software;
a file system including snapshot logic;
a storage subsystem to store user data and file system metadata, the file system to organize and access the user data based on the file system metadata,
the snapshot logic to create a snapshot of an entirety of the file system metadata stored in the storage subsystem, the snapshot not including the user data, wherein a non-extending write is allowed to change the file system during creation of the snapshot; and
a checker utility to perform a consistency check of the snapshot,
the file system to continue to access the user data using the file system metadata while the checker utility performs the consistency check.
